(19) United States
(12) Patent Application Publication
(10) Pub. No.: US 2010/0215926 A1
(43) Pub. Date: Aug. 26, 2010

(54) ALUMINUM ALLOY SUBSTRATES HAVING A MULTI-COLOR EFFECT AND METHODS FOR PRODUCING THE SAME

(76) Inventors: Albert L. Askin, Lower Burrell, PA (US); Daniel L. Serafin, Baden, PA (US); Paul Hergenroeder, Pittsburgh, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/711,855

(22) Filed: Feb. 24, 2010

Related U.S. Application Data
(60) Provisional application No. 61/208,640, filed on Feb. 25, 2009.

(51) Int. Cl. B32B 3/10; C23C 28/04

(52) U.S. Cl. 428/209; 205/202

(57) ABSTRACT

Aluminum alloy products having multi-color effects and methods of producing the same are disclosed. In one embodiment, the aluminum alloy product may be produced from high purity aluminum alloys. In some embodiments, the high purity aluminum alloys may be bright-rolled and/or mechanically polished to produce intended viewing surfaces having high image clarity.

### CROSS REFERENCE TO RELATED APPLICATIONS

This application claims priority to U.S. Provisional Patent Application Ser. No. 61/208,640 filed Feb. 25, 2009, which is incorporated herein by reference in its entirety.

### BACKGROUND

Visual appearance of consumer electronics, and other products, can be an important selling feature. However, achieving a visually appealing and durable aluminum alloy product can be elusive.

### SUMMARY

Aluminum alloy products having multi-color effects and methods of producing the same are disclosed. In one embodiment, an aluminum alloy product includes an aluminum alloy body having aluminum and alloying elements where the total amount of the alloying elements does not exceed about 5.0 wt. %.

The resulting aluminum alloy product generally includes an intended viewing surface. An oxide layer having a plurality of pores may be formed from the aluminum alloy body. This oxide layer may generally be associated with the intended viewing surface. In one embodiment, at least two colorants may at least partially fill the pores of the oxide layer.

The intended viewing surface, in one embodiment, may have a substantially multi-color effect, where a first portion of the aluminum alloy body has a first color due to a first colorant and a second portion of the aluminum alloy body has a second color due to a second colorant, the second color being different than the first color. The combination of the colors at least partially contributes to the multi-color effect.

In one embodiment, the aluminum alloy body may be rolled through a pair of polished work rolls to achieve an image clarity of at least about 85 at the intended viewing surface. In another embodiment, the aluminum alloy body may be mechanically polished to achieve an image clarity of at least about 85 at the intended viewing surface.

In one embodiment, a method of producing an aluminum alloy product having an intended viewing surface is disclosed. The producing step includes forming an aluminum alloy body having aluminum and alloying elements where the total amount of the alloying elements does not exceed about 5.0 wt. %. In addition, the aluminum alloy body may be rolled through a pair of polished work rolls. In another example, the aluminum alloy body may be mechanically polished. Furthermore, a combination of bright rolling and mechanical polishing may be incorporated. In some embodiments, the intended viewing surface may realize an image clarity of at least about 85 from bright rolling or mechanical polishing or both.

In one embodiment, after the producing step, the aluminum alloy body may be anodized by forming an oxide layer from a portion of the aluminum alloy body. The oxide layer may be similar to that described above having a plurality of pores and associated with the intended viewing surface.

Subsequently, a first colorant may be applied to the oxide layer whereby at least some of the first colorant may be partially disposed within the pores of the oxide layer. A second colorant may then be applied to the oxide layer whereby at least some of the second colorant may be similarly partially disposed within the pores of the oxide layer.

In some embodiments, after the two-colorant applying step, the intended viewing surface may have a substantially multi-color effect similar to that described above, whereby a first portion of the aluminum alloy product has a first color due to the first colorant, a second portion of the aluminum alloy product has a second color due to a second colorant, and where the second color is different than the first color. The combination of the colors at least partially contributes to the multi-color effect.

In some embodiments, the variability of colors realized by the multi-color effect at the intended viewing surface may be at least about 0.5 Delta E, or at least about 1.0 Delta E, or at least about 5.0 Delta E. In other embodiments, the aluminum alloy body may be formed of AA1080, AA1085, AA1090, AA5005 or AA5657.

Other variations, embodiments and features of the present disclosure will become evident from the following detailed description, drawings and claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a cross-sectional, schematic view of one embodiment of an aluminum alloy substrate having a multi-color effect.

FIG. 2 is a flow chart illustrating one embodiment of a method for producing an aluminum alloy substrate having a multi-color effect.

FIG. 3 is a flow chart illustrating one embodiment of a method for producing an aluminum alloy substrate having a multi-color effect.

FIG. 4 is a schematic, color view of an LCH diagram.

FIG. 5 is a schematic, color view of a CIE LAB diagram.

FIG. 6 is a color photograph illustrating one embodiment of an aluminum alloy substrate having a multi-color effect.

FIG. 7 is a color photograph illustrating one embodiment of an aluminum alloy substrate having a multi-color effect.

### DETAILED DESCRIPTION OF THE DISCLOSURE

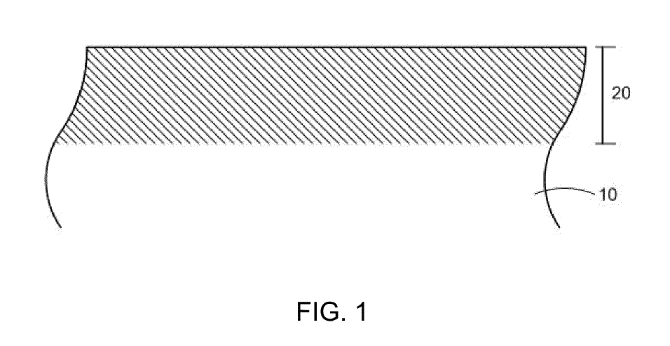

The present disclosure relates to aluminum alloy substrates having a multi-color effect. In particular, and with reference to FIG. 1, an aluminum alloy substrate 10 may include an electrochemically formed oxide zone 20. The electrochemically formed oxide zone 20 generally has a thickness of at least about 0.4 mil. The electrochemically formed oxide zone 20 may also have electrochemically formed pores having an average pore size of at least about 5 or 10 nanometers. The use of such an electrochemically formed oxide zone facilitates the use of multiple dying steps, which results in the aluminum alloy substrate realizing a multi-colored effect.

As used herein, “multi-color effect” and the like means that, after processing, a first portion of the aluminum alloy substrate shows a first visual effect (e.g., a first hue, a first chroma, and a first lightness, to produce a first color effect) when viewed at a first angle, but when viewed at a second angle (which is from 15 degrees to 165 degrees different than the first angle, or 30 degrees to 150 degrees different than the first angle), this first portion of the substrate shows a perceptibly different visual effect (i.e., a perceptibly different hue, chroma and/or lightness to produce a perceptibly different second color effect). In some instances, multi-color effect refers to the ability to see at least two different colors on the surface of a product when viewing the surface of the product from at least two different angles.

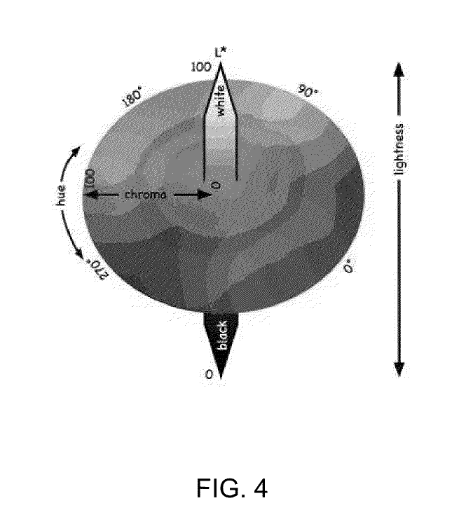

As used herein, “color” and the like means the perceived wavelength of visible light. A perceived color effect may include the components of lightness (L), chroma (C), and hue (H). Together these components are known as LCH. In one embodiment, LCH is replicated in the form of a sphere (illustrated in FIG. 4), having three axis, each axis separately corresponding to lightness, chroma and hue.

The vertical L* axis represents lightness, and ranges from 0 which has no lightness (i.e. absolute black) at the bottom, through 50 in the middle, to 100 which is maximum lightness (i.e. absolute white) at the top.

The C* axis represents chroma or “saturation”, and ranges from 0 at the center of the circle, which is completely unsaturated (i.e. a neutral grey, black or white) to 100 at the edge of the circle for maximum chroma or saturation.

If a horizontal slice is taken through the center of the sphere, a colored circle is formed. Around the edge of the circle is the possible ranges of saturated color, or “hue”. This circular axis is known as H° and stands for “hue”. The units are in the form of degrees, ranging from 0° (red) through 90° (yellow), 180° (green), 270° (blue) and back to 0°.

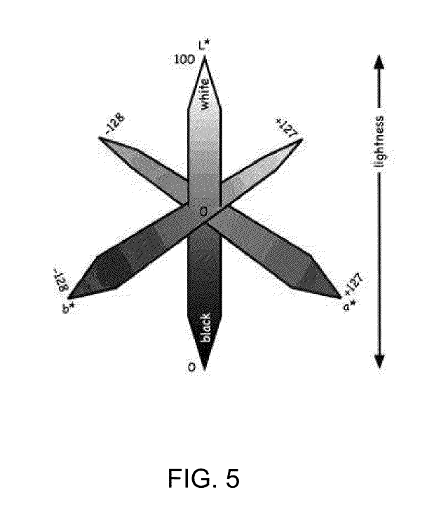

In another embodiment, the LCH is replicated using the L*a*b* standard. Just as in LCH, the vertical L* axis represents “lightness”, ranging from 0-100. The other (horizontal) axes are represented by a* and b*. These are at right angles to each other and cross each other in the center, which is neutral (grey, black or white). These crossing axis are based on the principal that a color cannot be both red and green, or blue and yellow. The a* axis is green at one extreme (represented by −a), and red at the other (+a). The b* axis has blue at one end (−b), and yellow (+b) at the other. The center of each axis is 0. A value of 0 or very low numbers of both a* and b* will give a neutral or near neutral. The L*a*b* concept is illustrated in FIG. 5, and is more commonly known as CIE Lab and is used in many industries, including printing, photography, dyes (including textiles, plastics, etc.), printing ink and paper, to name a few. Thus, in one embodiment, LCH and/or CIE Lab may be used, at least in part, to determine whether a substrate has a multi-color effect.

In a related embodiment, the multi-color effect of the substrate may be quantified via the use of Delta-E. As known to those skilled in the art, Delta-E is a number that represents the distance between two colors. Delta-E may be measured using LCH, LAB and other color parameters, and via a consistent illumination source (e.g., white light of a defined wavelength and wattage output) at a consistent, specified distance between the light and the substrate, and via one of the various Delta-E equations. In one embodiment, the Delta-E equation is based on dE76. In one embodiment, the Delta-E equation is based on dE94. In one embodiment, the Delta-E equation is based on dE-CMC. In one embodiment, the Delta-E equation is based on dE-CMC 2:1. In one embodiment, the Delta-E equation is based on dE2000. The parameters surrounding these Delta-E equations are known to those skilled in the art, and are described, for example, in:

(1) “Historical development of CIE recommended color difference equations”, by A. R. Robertson, Laboratory for Basic Standards National Research Council of Canada Ottawa, Ontario, Canada K1A OR6, Paper presented at the ISCC Conference on Color Discrimination Psychophysics, Williamsburg, Va., 1989, published in Color Research & Application, Vol. 15, Issue 3, Pages 167-170, published online 2007 by Wiley Periodicals, Inc., A Wiley Company.

(2) “The development of the CIE 2000 colour-difference formula: CIEDE2000”, by M. R. Luo et al. of the Colour & Imaging Institute, University of Derby, UK, in Color Research and Application, Vol. 26, Issue 5, pp. 340-350, published online 2001 by Wiley Periodicals, Inc., A Wiley Company.

Each of these publications is incorporated herein by reference in their entirety.

In one embodiment, the multi-color effect of the substrate has a Delta-E of at least about 0.5. In other embodiments, the multi-color effect of the substrate has a Delta-E of at least about 1, or a Delta-E of at least about 2, or a Delta-E of at least about 3, or a Delta-E of at least about 4, or a Delta-E of at least about 5, or a Delta-E of at least about 6, or a Delta-E of at least about 7, or a Delta-E of at least about 8, or a Delta-E of at least about 9, or a Delta-E of at least about 10. Higher Delta-E values may be achievable. In some instances, a Delta-E of at least about 0.5 may be visible to the naked eye. The Delta-E may be measured using a consistent illumination source, located at a specified distance from the substrate, and a photometer/colorimeter device that allows for color measurement at different illumination/viewing angles. This will be described in more detail below.

To determine the color difference at two different viewing angles, the color values may be measured by an optical instrument at a first angle, and a second angle, and the Delta-E may be determined by a photometer-colorimeter. The second angle is generally at least 15 degrees different than the second angle, but is generally not more than 165 degrees different than the first angle.

For instance, the multi-color effect may be measured using an optical instrument having a high color rendering index (CRI) light source, a photometer/colorimeter, and a baffle for filtering (e.g., blocking) light from the light source to the photometer/colorimeter. A sample (e.g., aluminum alloy substrate) may be placed on a stage and subjected to light from the light source located at a specified distance from the stage. The photometer/colorimeter may be directed at the sample for measuring the reflected colors from the sample at a first angle. The reflected colors may be measured again after manipulating (e.g., electronically, mechanically, manually) the photometer-colorimeter to a second angle, the second angle being different than the first angle. In some instances, the photometer/colorimeter may be fixed and the stage or the light source or both may be manipulated to a second angle. In general, the photometer/colorimeter may be capable of measuring both the light intensity and the color of light (e.g., reflected light). In some instances, a photometer/radiometer may be used in place of the photometer/colorimeter. In other instances, any device, whether standalone or in combination, capable of measuring both the light intensity and the color of the light, may be used to measure the multi-color effect.

In one embodiment, the multi-color effect may be directed to three-dimensional (3D) objects. For example, the multi-color effect may be visible on 3D parts with the multi-color effect being visible due to the viewing angles. In some instances, different colors may be observed on the 3D part because of the contour of the viewing surface and at different angles.

In addition to having a multi-color effect, the aluminum alloy substrates may be durable. In one embodiment, the aluminum alloy substrates are abrasion/scratch-resistant. In one embodiment, the aluminum alloy products are able to consistently pass a pencil hardness test as defined by ASTM D3363-05. In these pencil hardness tests, the aluminum alloy substrate may consistently pass/achieve a level 8H or 9H rating. The aluminum alloy substrates may also have a high gloss or shine, for example, as determined by a gloss meter. In one embodiment, the gloss is at least equivalent to the gloss achieved via a painted substrate of similar color.

The aluminum alloy substrates of the present disclosure may be utilized in a variety of consumer products, such as any consumer electronic products, including laptops, cell phones, cameras, mobile music players, handheld devices, computers, televisions, microwave, cookware, washer/dryer, refrigerator, sporting goods, or any other consumer electronic product requiring durability and selective visual appearance. In one embodiment, the visual appearance of the consumer electronic product meets consumer acceptance standards.

In some embodiments, the aluminum alloy substrates of the present disclosure may be utilized in a variety of products including non-consumer products including the likes of medical devices, transportation systems and security systems, to name a few. In other embodiments, the aluminum alloy substrates may be incorporated in goods including the likes of car panels, DVD players, bottles and cans, office supplies, packages and containers, among others.

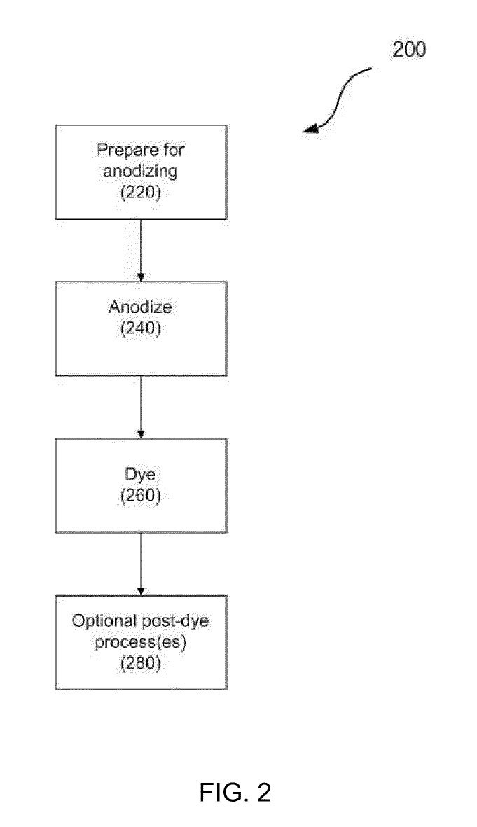

Methods of producing aluminum alloy substrates have a multi-color effect are also disclosed, one embodiment of which is illustrated in FIG. 2. In the illustrated embodiment, the method 200 includes the steps of preparing an aluminum alloy substrate for oxide layer formation (220), electrochemically forming an oxide layer in the aluminum alloy substrate (240), dying the aluminum alloy substrate (260), and one or more optional post-dye processes (280).

The preparing step (220) may include any number of steps useful in preparing the aluminum alloy substrate for formation of the electrochemically formed oxide layer. For example, and as described in further detail below, the preparing step (220) may include producing the aluminum alloy substrate (e.g., via rolling, extrusion, forging, and/or casting processes), cleaning the substrate, and/or chemically brightening the substrate.

The step of electrochemically forming the oxide layer in the substrate (240) may be accomplished via any suitable apparatus or processes, such as anodizing. As discussed in further detail below, in a particular embodiment, the anodizing comprises Type II anodizing using sulfuric acid to produce an oxide layer having a thickness of at least about 0.4 mils.

The step of dying the substrate (260) may include immersing the substrate in one or more dye baths, with optional rinsing between and/or after the dying steps.

The optional post-dye processes (280) may include sealing the dyed aluminum alloy substrate and/or polishing the dyed aluminum alloy substrate, as described in further detail below.

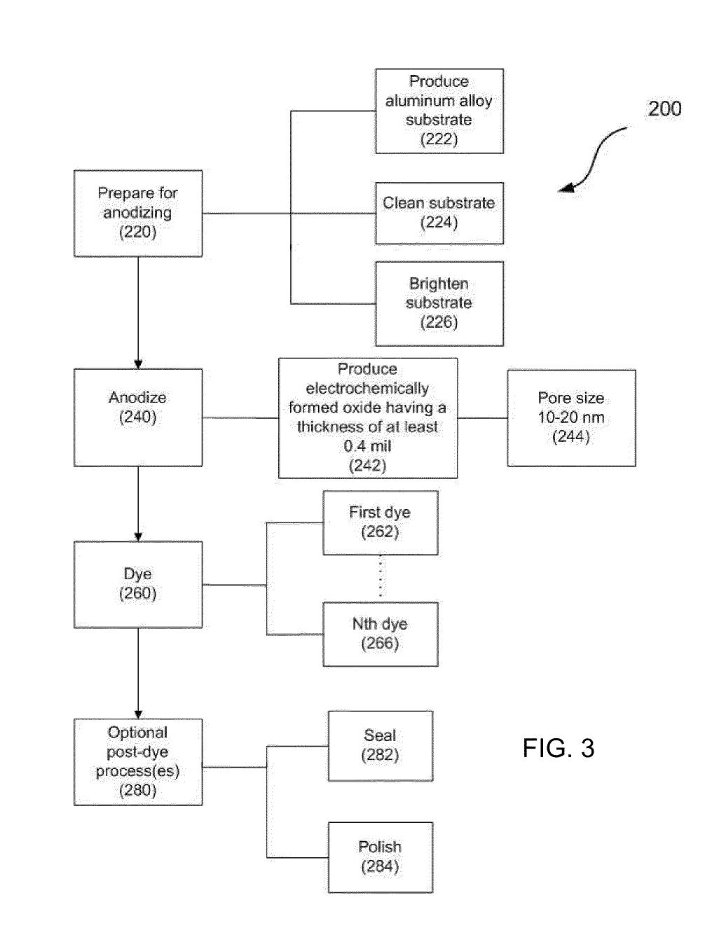

One particular embodiment of producing an aluminum alloy substrates having a multi-color effect is illustrated in FIG. 3. In the illustrated embodiment, the method (200) includes the steps of preparing the aluminum alloy substrate for anodizing (220), anodizing the aluminum alloy substrate (240), dying the aluminum alloy substrate (260), and one or more optional post-dye processes (280).

In the illustrated embodiment, the step of preparing the aluminum alloy substrate for anodizing (220) includes the steps of producing the aluminum alloy substrate (222), cleaning the aluminum alloy substrate (224), and brightening (e.g., electrochemically polishing, or chemical polishing) the aluminum alloy substrate (226).

With respect to the step of producing the aluminum alloy substrate (222), the aluminum alloy substrate may be produced via any suitable aluminum alloy production processes, including wrought processes, such as rolling, extruding, and/or forging, and non-wrought processes, such as casting and/or powder metallurgy. In one embodiment, the produced aluminum alloy is one of an 1xxx, 3xxx, 5xxx, or 6xxx series aluminum alloy, or similar alloys. These types of alloys may be more suitable for producing substrates having a multi-color effect. However, in other embodiments, the aluminum alloys may be any of a 2xxx, 4xxx, 7xxx, and/or 8xxx series aluminum alloys or similar alloys. The 1xxx, 2xxx, 3xxx, 4xxx, 5xxx, 6xxx, 7xxx and 8xxx series aluminum alloys mean Aluminum Association alloys 1xxx, 2xxx, 3xxx, 4xxx, 5xxx, 6xxx, 7xxx and 8xxx, respectively, as defined by the Aluminum Association Teal Sheets.

In one embodiment, the step of producing the aluminum alloy substrate (222) includes producing an aluminum alloy body having aluminum and alloying elements, with the total amount of the alloying elements not exceeding about 5.0 wt. %.

As used herein, “alloying elements” mean any non-aluminum elements that may be added to aluminum wrought alloys or casting alloys in various quantities. Examples of alloying elements include copper, nickel, manganese, silicon, magnesium, zinc, and combinations thereof, among others. In some instances, the alloying elements may include incidental elements and impurities. In some embodiments, the total amount of the alloying elements in the aluminum alloy body does not exceed about 4.5 wt. %, or does not exceed about 4.0 wt. %, or does not exceed about 3.5 wt. %, or does not exceed about 3.0 wt. %, or does not exceed about 2.5 wt. %, or does not exceed about 2.0 wt. %, or does not exceed about 1.5 wt. %, or does not exceed 1.0 wt. %, or does not exceed about 0.5 wt. %.

As used herein, “incidental elements” mean those elements or compounds that may optionally be added to the alloy to assist in the production of the alloy. Examples of incidental elements include casting aids and grain refiners (e.g., titanium, boron, titanium combined with boron or carbon).

As used herein, “impurities” are those materials that may be present in the alloy in minor amounts due to, for example, the inherent properties of aluminum and/or leaching from contact with manufacturing equipment. Iron (Fe) and silicon (Si) are examples of impurities generally present in aluminum alloys.

In some embodiments, the step of producing the aluminum alloy substrate (222) includes producing an aluminum alloy body having at least one of AA1080, AA1085 and AA1090. AA1080, AA1085 and AA1090 mean Aluminum Association alloys 1080, 1085 and 1090, respectively, as defined by the Aluminum Association Teal Sheets. In other embodiments, the step of producing the aluminum alloy substrate (222) includes producing an aluminum alloy body having at least one of AA5005 and AA5657. AA5005 and AA5657 mean Aluminum Association alloys 5005 and 5657, respectively, as defined by the Aluminum Association Teal Sheets.

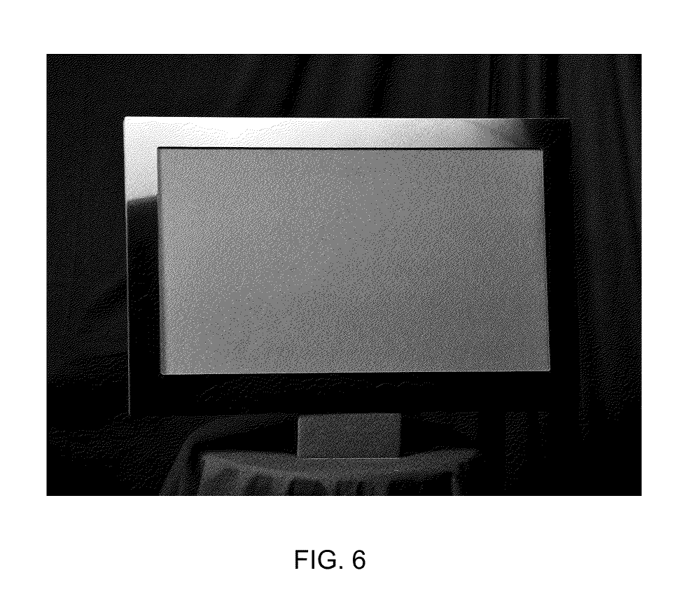

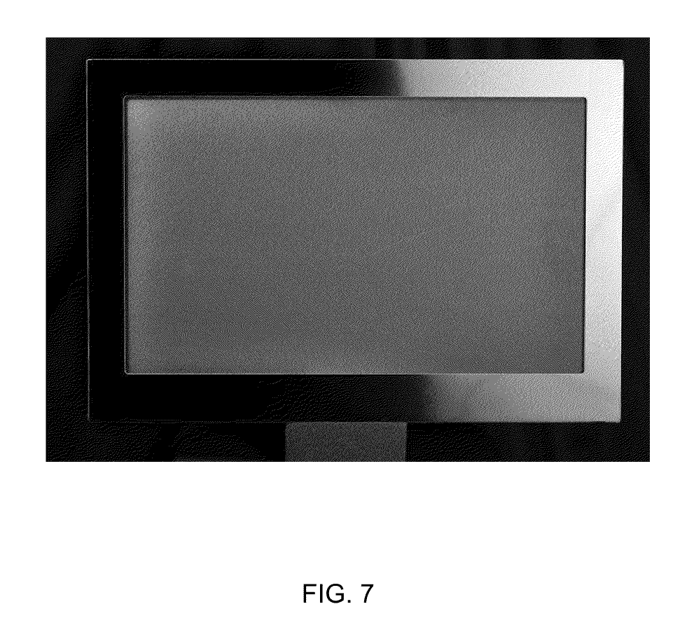

The process of producing the aluminum alloy substrate (222) may also produce intended viewing surfaces. In general, intended viewing surfaces, such as the exterior surfaces of the screens of FIGS. 6-7, are surfaces that are intended to be viewed during normal use of the product.

In one embodiment, the variability of the colors realized by the multi-color effect at the intended viewing surface is at least about 0.5 Delta E. As used herein, “variability of the colors” and the like means the difference in color between the first color and the second color as measured via an optical instrument. In some embodiments, the variability of the colors realized by the multi-color effect at the intended viewing surface is at least about 1.0 Delta E, or at least about 2.0 Delta E, or at least about 3.0 Delta E, or at least about 4.0 Delta E, or at least about 5.0 Delta E, or at least about 6.0 Delta E, or at least about 7.0 Delta E, or at least about 8.0 Delta E, or at least about 9.0 Delta E, or at least about 10.0 Delta E.

In one embodiment, the produced aluminum alloy substrate is a rolled substrate, such as a foil, sheet, or plate product. As used herein, “rolling” and the like means a fabrication process in which aluminum metal is passed through a pair (or pairs) of rolls. For example, one type of rolling process is flat rolling where the final shape of the product can be aluminum sheet or aluminum plate.

“Aluminum sheet” and the like means a rolled aluminum product having a thickness of at least about 201 microns and not greater than about 0.249 inches (6324.6 microns).

“Aluminum plate” and the like means a rolled aluminum product having a thickness of at least about 0.249 inches (6324.6 microns).

“Aluminum foil” and the like means a rolled aluminum product having a thickness of not greater than 200 microns. Rolled products may realize an enhanced brightness due to, for example, the use of rolls, which may improve the multi-color effect of the aluminum alloy substrate.

In one embodiment, the process of producing the aluminum alloy substrate (222) may include rolling the aluminum alloy substrate through a pair of polished work rolls to produce an intended viewing surface having a higher image clarity or distinctness of image. Specifically, the smoothness of the work roll may be transferred to the surface of the aluminum alloy substrate via the rolling process.

As used herein, “work roll” and the like is a roller disposed about a rolling mill that comes in contact with the material to be rolled. For example, the work roll may contact an aluminum alloy sheet, plate or foil. A polished work roll is a work roll that is substantially pristine or without any substantial defects. In some instances, polished work rolls may be newly manufactured work rolls that have not been used in any rolling process. In other instances, polished work rolls may be work rolls that have been mechanically or chemically polished to provide rollers that are substantially pristine or without any substantial defects.

The process of rolling the aluminum alloy substrate through the polished work roll may also be referred to as bright rolling. In one embodiment, the aluminum alloy substrate may achieve an image clarity of at least about 85 at the intended viewing surface after bright rolling.

As used herein, “image clarity” and the like is a measure of the mirror-like qualities of a surface ranging from a scale of 0 to 100 with 0 being a surface that completely diffuses light and 100 being a perfect mirror (e.g., a theoretical mirror that reflects light perfectly and doesn't transmit or absorb it). In some instances, image clarity may also be referred to as distinctness of image, which can be measured using an optical instrument (e.g., HunterLab Dorigon). In general, the higher the image clarity, the easier it may be to see the multi-color effect as the color differences tend to “pop” on the surface of the aluminum alloy substrate.

In one embodiment, after bright rolling (e.g., rolling with polished work rolls), the intended viewing surface of the aluminum alloy body may realize an image clarity of at least about 85. In some embodiments, the image clarity may be at least about 86, or at least about 87, or at least about 88, or at least about 89, or at least about 90, or at least about 91, or at least about 92, or at least about 93, or at least about 94, or at least about 95, or at least about 96, or at least about 97, or at least about 98, or at least about 99.

In one example, the intended viewing surface of a bright-rolled aluminum alloy body may realize an image clarity of about 94 as measured with the rolling direction. In another example, the intended viewing surface of a bright-rolled aluminum alloy body may realize an image clarity of about 90 as measured across the rolling direction. In some instances, the intended viewing surface of a bright-rolled aluminum alloy body may realize image clarity values higher than 90 as measured across the grain.

In one embodiment, the produced aluminum alloy substrate is an extruded substrate. As used herein, “extruding” and the like means a fabrication process in which aluminum metal is pushed or drawn through a die to create an object having a fixed, cross-sectional profile, such as, for example, an aluminum rod.

In one embodiment, the produced aluminum alloy substrate is a forged substrate. As used herein, “forging” and the like means a manufacturing process for shaping aluminum metal using localized compressive forces.

In one embodiment, the produced aluminum alloy substrate is a cast substrate. As used herein, “casting” and the like means a manufacturing process by which liquid aluminum is poured into a mold, which contains a hollow cavity of the desired shape of the aluminum product, and then allowed to solidify. The solidified aluminum metal, also known as a casting, can be ejected or broken out of the mold to produce the desired aluminum product.

With respect to the cleaning step (224), this cleaning may be accomplished by any known conventional processes and/or cleaning agents, such as via the use of acidic and/or basic cleansers or detergents that produce a water break free surface (water wettable). In one embodiment, the cleaning agent is a non-alkaline cleaner, such as A-31K manufactured by Henkel International, Germany. For example, the cleaning step (224) may include cleaning the intended viewing surface of the aluminum alloy substrate with a non-etching alkaline cleaner for about 2 minutes to remove lubricants or other residues that may have formed during the bright-rolling step. After the cleaning step (224), the substrate may be rinsed or double rinsed with a suitable rinsing agent, such as water. In one embodiment, the suitable rinsing agent is de-ionized water. Other suitable rinsing agents may be utilized.

With respect to the brightening step (226), the brightening may include electrochemical or chemical polishing. The electrochemical polishing may be accomplished via any suitable processes, such as via use of an electrolyte in the presence of current. Some methods of electrochemical polishing are disclosed in U.S. Pat. No. 4,740,280, which is incorporated herein by reference in its entirety. The chemical brightening (polishing) may be accomplished via any suitable processes, such as via a mixture of phosphoric acid and nitric acid in the presence of water, or via the methods described in U.S. Pat. No. 6,440,290 to Vega et al., which is incorporated herein by reference in its entirety. For example, the brightening step (226) may include chemical etching by immersing in a phosphoric acid-based solution (e.g., DAB80) for a period of about 2 minutes to about 4 minutes, followed by a warm bath double rinse similar to that discussed above, immersion in a 50% nitric acid solution at room temperature for about 30 seconds, and another double rinse step.

In one embodiment, the brightening step (226) may include mechanical polishing by grinding, roughing, oiling or greasing, buffing or mopping, and coloring, among other suitable mechanical processes.

As used herein, “polishing” and the like means to smooth or brighten a surface to increase the reflective quality and luster, such as mechanical polishing by grinding, polishing and buffing, or to improve the surface conditions of the aluminum product for decorative or functional purposes. For example, mechanical polishing may be utilized to increase gloss.

In some embodiments, after mechanical polishing, the intended viewing surface of the aluminum alloy substrate may realize an image clarity of at least about 85, or at least about 86, or at least about 87, or at least about 88, or at least about 89, or at least about 90, or at least about 91, or at least about 92, or at least about 93, or at least about 94, or at least about 95, or at least about 96, or at least about 97, or at least about 98, or at least about 99.

In one embodiment, the aluminum alloy substrate may be first bright rolled followed by mechanical polishing to produce high image clarity at the intended viewing surface of the aluminum alloy substrate.

With respect to the anodizing step (240), the anodizing may be accomplished via any suitable electrolyte, current density, and temperature so long as an oxide zone/layer having a thickness of at least about 0.4 mil (242) is produced. Furthermore, the pore size of the oxide layer may be in the range of 1 to 40 nanometers, such as in the range of 10 to 20 nanometers (244). In one embodiment, the anodizing step includes utilizing an electrolyte having 12 to 25 wt. % H₂SO₄, a current density of 8 to 24 amps per square foot (ASF), and with an electrolyte temperature of between 60° F. to 80° F.

As used herein, “anodizing” and the like means those processes that produce an oxide zone of a selected thickness in a substrate via application of current to substrate while the substrate is in the presence of an electrolyte.

In one embodiment, the electrolyte comprises at least 12 wt. % sulfuric acid, such as at least 14 wt. % sulfuric acid. In one embodiment, the electrolyte comprises not greater than 25 wt. % sulfuric acid. In other embodiments, the electrolyte comprises not greater than 22 wt. % sulfuric acid, or not greater than 20 wt. % sulfuric acid.

In some embodiments, the electrolyte includes at least one of phosphoric acid, boric/sulfuric acid, chromic acid, and oxalic acid, among other suitable acid mediums.

In one embodiment, the current density during anodizing is at least about 8 ASF. In other embodiments, the current density is at least about 10 ASF or at least about 12 ASF. In one embodiment, the current density is not greater than about 24 ASF. In other embodiments, the current density is not greater than about 20 ASF, or not greater than about 18 ASF.

In one embodiment, the temperature of the electrolyte during anodizing is at least about 40° F. In other embodiments, the temperature of the electrolyte during anodizing is at least about 50° F., such as at least about 60° F. In one embodiment, the temperature of the electrolyte during anodizing is not greater than about 100° F. In other embodiments, the temperature of the electrolyte during anodizing is not greater than 90° F., such as not greater than 80° F.

In one embodiment, the anodizing step (240) produces an electrochemically formed oxide zone in the substrate, the electrochemically formed oxide zone having a thickness of at least about 0.4 mil. In one embodiment, the thickness of the oxide zone is at least about 0.5 mil. The use of an oxide zone thickness of at least about 0.4 mil or at least about 0.5 mil may facilitate the absorption of dye during the subsequent dying step (260) and the production of aluminum alloy substrates having a multi-color effect. Aluminum alloy substrates having an oxide zone thickness of less than 0.3 mil may not facilitate realization of the production of aluminum alloy substrates having a multi-color effect. The thickness of the electrochemically formed oxide zone may be alloy-dependent, but generally does not exceed 2 mils. For instance, higher strength aluminum alloy substrates, such as those including increased levels of magnesium, may not realize a visually appealing, multi-color effect with oxide zone thicknesses above 1 mil. However, aluminum alloys having less alloying constituents may use oxide zones having thicknesses in excess of 1 mil and still be able to achieve visually appealing, aluminum alloy substrates having a multi-color effect.

The pore size of the electrochemically formed oxide zone may also facilitate production of aluminum alloy substrates having a multi-color effect. The oxide layer of the aluminum alloy substrates may have pore sizes of at least about 1 nanometer, and not greater than about 40 nanometers to facilitate dye absorption in the dying step (260), and thus facilitate production of aluminum alloy substrates having a multi-color effect.

In one embodiment, the average pore size of the pores of the electrochemically formed oxide zone is at least about 5 nanometers. In other embodiments, the average pore size is at least about 7 nanometers, or even at least about 10 nanometers. In one embodiment, the average pore size of the pores of the electrochemically formed oxide zone does not exceed about 30 nanometers. In one embodiment, the average pore size is not greater than about 25 nanometers, such as not greater than about 20 nanometers. In one embodiment, the average pore size of the pores of the electrochemically formed oxide zone is in the range of 10 to 20 nanometers.

In one embodiment, after the anodizing step (240), the aluminum alloy substrate may be subjected to a double rinse step, followed by immersion in a 50% nitric acid solution at room temperature for about 60 seconds, and another double rinse step.

In one embodiment, an oxide layer 20 (e.g., oxide zone) may be formed from the aluminum alloy substrate 10, the oxide layer 20 containing a plurality of pores as discussed above (see FIG. 1). In this instance, the oxide layer 20 may be associated with the intended viewing surface of the aluminum alloy substrate 20. Subsequent processing steps may add colors to the oxide layer 20 to produce the multi-color effect on the intended viewing surface of the aluminum alloy substrate 20.

With respect to the dying substrate step (260), the dying may include at least a first dying step (262), and at least one additional dying step (266). In one embodiment, the dying step (260) includes at least two dying steps. Additional dying sequences may be used.

As used herein, “dye” and the like means a color material used for coloring a substrate. Dyes may be any suitable color, such as red, orange, yellow, green, blue, indigo, violet, black, white, and mixtures thereof. Dyes are usually water-based, and placed in contact with substrates via immersion techniques. However, dyes may be applied to the substrate in other ways, such as, for example, via spraying, spraying-immersion, and the like. Irrespective of the manner of application of the dye, the dye should contact the surface of the oxide zone (20) of the aluminum alloy substrate (10) for a sufficient amount of time to enable the pores of the oxide zone (20) to retain the dye (e.g., via absorption).

In one embodiment, the dye is an aqueous-based dye. Examples of suitable dyes include those produced by Clariant, Pigments and Additives Division, 500 Washington Street, Coventry, R.I., 02816 United States (www.pa.clariant.com).

In one embodiment, the first dying step (262) comprises immersing the aluminum alloy substrate in a first dye having a concentration in the range of 0.1 grams per liter 20 grams per liter, for a period of 10 to 180 seconds, at a temperature from 90° F. to 190° F. and a pH from 4 to 7. In one embodiment, the concentration of the dye is at least about 0.2 grams per liter. In other embodiments, the concentration of the dye is at least about 0.5 grams per liter, or at least about 1 gram per liter, or at least about 2 grams per liter. In one embodiment, the concentration of the dye does not exceed 20 grams per liter. In other embodiments, the concentration of the dye is not greater than about 15 grams per liter, such as not greater than about 10 grams per liter.

In one embodiment, the temperature of the dye during the dying step is in the range of 90° F. to 190° F. In one embodiment, the temperature of the dye during the dying step is at least about 90° F. In other embodiments, the temperature of the dye during the dying step is at least about 110° F., such as at least about 120° F. In one embodiment, the temperature of the dye during the dying step is not greater than about 190° F. In other embodiments, the temperature of the dye during the dying step is not greater than about 175° F., such as not greater than about 160° F. In one embodiment, the temperature of the dye during the dying step is in the range of 130° F. to 150° F. In one embodiment, the temperature of the dye during the dying step is in the range of 135° F. to 145° F.

In one embodiment, the substrate is immersed in the dye for a time period in the range of 10 seconds to 180 seconds. In one embodiment, the substrate is immersed in the dye for at least about 10 seconds. In other embodiments, the substrate is immersed in the dye for at least about 20 seconds, such as at least about 30 seconds. In one embodiment, the substrate is immersed in the dye for not greater than about 3 minutes. In other embodiments, the substrate is immersed in the dye for not greater than about 90 seconds, such as not greater than about 60 seconds.

In one embodiment, the dying solution is at a pH in the range of 4 to 7 during the dying. In one embodiment, the pH of the dying solution is at least about 4. In other embodiments, the pH of the dying solution may be at least about 4.5, or at least about 5. In one embodiment, the dying solution has a pH of not greater than about 7. In other embodiments, the dying solution has a pH of not greater than about 6.5, or not greater than about 6. In one embodiment, the dying solution has a pH in the range of 5 to 6.

Like above, after the first dying step (262), the substrate may be rinsed or double rinsed with de-ionized water.

With respect to the second, or subsequent, dying steps (266), the dying parameters, such as dye concentration, dye temperature and/or dye time, may be similar to those utilized in the first dying step. However, the color of the dye used in the second dying step is different than the color of the dye used in the first dying step. In other words, the dyes of the at least two dying steps should be of sufficient color difference so as to facilitate production of aluminum alloy substrates having a multi-color effect, as described above.

For example, the color of the dye during the first dying step may be in the red range of the visible light spectrum, and the second dye of the second dying step may be, for instance, blue. Numerous other color dying combinations are possible. After the additional dying step(s), the substrate may again be double rinsed with a rinsing agent.

In one embodiment, a combination of a first color from a first dying step (262) and a second color from a second dying step (266) may at least partially contribute to the multi-color effect. For example, a first portion (e.g., oxide layer 20) of the aluminum alloy body 10 may have a first color due to the first dying step (262) while a second portion (e.g., oxide layer 20) of the aluminum alloy body 10 may have a second color due to the second dying step (266), the second color being different from the first color. In some instances, the colors may fill the pores of the oxide layer 20 in sequential order to produce the multi-color effect on the intended viewing surface of the aluminum alloy substrate. In other instances, the colors may be intermixing within the pores of the oxide layer 20 to produce the multi-color effect on the intended viewing surface of the aluminum alloy substrate. In some embodiments, subsequent colors from subsequent dying steps (266) may at least partially contribute to the multi-color effect.

With respect to the optional post-dye processes (280), such processes may include one or more of sealing the dyed aluminum alloy substrate (282) and polishing the aluminum alloy substrate (284).

With respect to the sealing step (282), the sealing may be useful to close the oxide pores or prevent the color of the dyes from bleeding or leaking out of the oxide zone. The sealing step can be accomplished via any known conventional processes, such as by hot sealing with de-ionized water or steam or by cold sealing with impregnation of a sealant in a room-temperature bath. In one approach, at least some, or in some instances all or nearly all, of the pores of the oxide zone may be sealed with a sealing agent, such as, for instance, an aqueous salt solution at elevated temperature (e.g., boiling salt water) or nickel acetate. After the sealing step the substrate may again be double rinsed with a rinsing agent.

With respect to the polishing step (284), the polishing may be accomplished via any suitable means so as to increase, for example, the gloss of the aluminum alloy substrate. It will be appreciated that, while the polishing step (284) may be used to increase the gloss of the aluminum alloy substrate, the polishing step does not facilitate production of an aluminum alloy substrate having a multi-color effect.

### Examples

### Example 1

An aluminum alloy substrate (AA5657) is rolled into sheet having a thickness of about 0.2 inch. The sheet is then mechanically polished, cleaned and chemically brightened. The sheet is then anodized in an electrolyte containing 20 wt. % sulfuric acid at a temperature of about 60° F. to 80° F., and a current density of about 12 ASF to produce an electrochemically formed oxide zone in the substrate. The oxide zone has a thickness of at least about 0.5 mil. The substrate is then immersed in a water-based red dye (e.g., Clariant Bordeaux BL) for about 30 seconds. The temperature of the dye during the immersion step is about 140° F., and the concentration of the dye is about 5 grams per liter. The substrate is then rinsed in de-ionized water, and then immersed in a water-based black dye (e.g., Clariant Black HBL) for about 30 seconds. The temperature of the dye during the immersion step is about 140° F., and the concentration of the dye is about 5 grams per liter. The substrate is sealed in a nickel acetate solution at about 200° F. The substrate achieves a multi-color effect, as illustrated in FIG. 6.

### Example 2

An aluminum alloy substrate (AA5657) is rolled into sheet having a thickness of about 0.2 inch. The sheet is then mechanically polished, cleaned and chemically brightened. The sheet is anodized in an electrolyte containing 20 wt. % sulfuric acid, at a temperature of about 60° F. to 80° F., and a current density of about 12 ASF to produce an electrochemically formed oxide zone in the substrate. The oxide zone has a thickness of at least about 0.5 mil. The substrate is then immersed in a water-based blue dye (e.g., Clariant Blue 4A) for about 30 seconds. The temperature of the dye during the immersion step is about 140° F., and the concentration of the dye is about 2 grams per liter. The substrate is then rinsed in de-ionized water, and then immersed in a water-based black dye (e.g., Clariant Black HBL) for about 30 seconds. The temperature of the dye during the immersion step is about 140° F., and the concentration of the dye is about 5 grams per liter. The substrate is sealed in a nickel acetate solution at about 200° F. The substrate achieves a multi-color effect, as illustrated in FIG. 7.

While various embodiments of the present disclosure have been described in detail, it is apparent that modifications and adaptations of those embodiments will occur to those skilled in the art. However, it is to be expressly understood that such modifications and adaptations are within the spirit and scope of the present disclosure.

What is claimed is:

1. An aluminum alloy product comprising:
(a) an aluminum alloy body having aluminum and alloying elements, wherein the total amount of the alloying elements does not exceed about 5.0 wt. %, and wherein the aluminum alloy body includes an intended viewing surface;
(b) an oxide layer formed from the aluminum alloy body, wherein the oxide layer contains a plurality of pores, wherein the oxide layer is associated with the intended viewing surface, and wherein at least two colorants at least partially fills the pores of the oxide layer; and
wherein the intended viewing surface has a substantially multi-color effect, wherein a first portion of the aluminum alloy body has a first color due to a first colorant, wherein a second portion of the aluminum alloy body has a second color due to a second colorant, wherein the second color is different than the first color, and wherein the combination of the first color and the second color at least partially contributes to the multi-color effect.

2. The product of claim 1, wherein the aluminum alloy body is rolled through a pair of polished work rolls to achieve an image clarity of at least about 85 at the intended viewing surface.

3. The product of claim 1, wherein the aluminum alloy body is mechanically polished to achieve an image clarity of at least about 85 at the intended viewing surface.

4. The product of claim 1, wherein variability of the colors realized by the multi-color effect at the intended viewing surface is at least about 0.5 Delta E.

5. The product of claim 1, wherein variability of the colors realized by the multi-color effect at the intended viewing surface is at least about 1.0 Delta E.

6. The product of claim 1, wherein variability of the colors realized by the multi-color effect at the intended viewing surface is at least about 5.0 Delta E.

7. The product of claim 1, wherein the aluminum alloy body is at least one of AA1080, AA1085 and AA1090.

8. The product of claim 1, wherein the aluminum alloy body is at least one of AA5005 and AA5657.

9. A method comprising:
(a) producing an aluminum alloy product having an intended viewing surface, wherein the producing step includes:
(i) forming an aluminum alloy body having aluminum and alloying elements, wherein the total amount of the alloying elements does not exceed about 5.0 wt. %; and
(ii) rolling the aluminum alloy body through a pair of polished work rolls;
(b) anodizing the aluminum alloy body, wherein the anodizing step includes forming an oxide layer from a portion of the aluminum alloy body, the oxide layer having a plurality of pores, and wherein the oxide layer is associated with the intended viewing surface;
(c) applying a first colorant to the oxide layer, wherein after the applying step (c) at least some of the first colorant is at least partially disposed within the pores of the oxide layer;
(d) applying a second colorant to the oxide layer, the second colorant being a different color than the first colorant, wherein after the applying step (d) at least some of the second colorant is at least partially disposed within the pores of the oxide layer; and
wherein, after the applying steps (c) and (d), the intended viewing surface has a substantially multi-color effect, wherein a first portion of the aluminum alloy product has a first color due to the first colorant, wherein a second portion of the aluminum alloy product has a second color due to a second colorant, wherein the second color is different than the first color, and wherein the combination of the first color and the second color at least partially contributes to the multi-color effect.

10. The method of claim 9, wherein after the producing step (a), the intended viewing surface realizes an image clarity of at least about 85.

11. The method of claim 9, wherein the producing step (a) further includes:
(iii) mechanically polishing the aluminum alloy body, wherein the intended viewing surface realizes an image clarity of at least about 85.

12. The method of claim 9, wherein variability of the colors realized by the multi-color effect at the intended viewing surface is at least about 0.5 Delta E.

13. The method of claim 9, wherein variability of the colors realized by the multi-color effect at the intended viewing surface is at least about 1.0 Delta E.

14. The method of claim 9, wherein variability of the colors realized by the multi-color effect at the intended viewing surface is at least about 5.0 Delta E.

15. The method of claim 9, wherein the aluminum alloy body is at least one of AA 1080, AA 1085, AA 1090, AA 5005 and AA 5657.

16. A method comprising:
(a) producing an aluminum alloy product having an intended viewing surface, wherein the producing step includes:
(i) forming an aluminum alloy body having aluminum and alloying elements, wherein the total amount of the alloying elements does not exceed about 5.0 wt. %; and
(ii) mechanically polishing the aluminum alloy body, wherein the intended viewing surface realizes an image clarity of at least about 85;
(b) anodizing the aluminum alloy body, wherein the anodizing step includes forming an oxide layer from a portion of the aluminum alloy body, the oxide layer having a plurality of pores, and wherein the oxide layer is associated with the intended viewing surface;
(c) applying a first colorant to the oxide layer, wherein after the applying step (c) at least some of the first colorant is at least partially disposed within the pores of the oxide layer;
(d) applying a second colorant to the oxide layer, the second colorant being a different color than the first colorant, wherein after the applying step (d) at least some of the second colorant is at least partially disposed within the pores of the oxide layer; and
wherein, after the applying steps (c) and (d), the intended viewing surface has a substantially multi-color effect, wherein a first portion of the aluminum alloy product has a first color due to the first colorant, wherein a second portion of the aluminum alloy product has a second color due to a second colorant, wherein the second color is different than the first color, and wherein the combination of the first color and the second color at least partially contributes to the multi-color effect.

17. The method of claim 16, wherein variability of the colors realized by the multi-color effect at the intended viewing surface is at least about 0.5 Delta E.

18. The method of claim 16, wherein variability of the colors realized by the multi-color effect at the intended viewing surface is at least about 1.0 Delta E.

19. The method of claim 16, wherein variability of the colors realized by the multi-color effect at the intended viewing surface is at least about 5.0 Delta E.

20. The method of claim 16, wherein the aluminum alloy body is at least one of AA 1080, AA 1085, AA 1090, AA 5005 and AA 5657.
